(19) United States
(12) Patent Application Publication
(10) Pub. No.: US 2026/0279638 A1
(43) Pub. Date: Sep. 17, 2026

(54) COIL COMPONENT

(71) Applicant: SAMSUNG ELECTRO-MECHANICS CO., LTD., Suwon-si (KR)

(72) Inventors: Jong Pil LEE, Suwon-si (KR); Tai Yon CHO, Suwon-si (KR); Boum Seock KIM, Suwon-si (KR); Tae Hyung KOO, Suwon-si (KR); Hyeong Joo JIN, Suwon-si (KR); A Reum KIM, Suwon-si (KR); Sung Hwan PARK, Suwon-si (KR); Jong Suk JUNG, Suwon-si (KR)

(73) Assignee: SAMSUNG ELECTRO-MECHANICS CO., LTD., Suwon-si (KR)

(21) Appl. No.: 19/439,619

(22) Filed: Jan. 5, 2026

(30) Foreign Application Priority Data
Mar. 13, 2025 (KR) 10-2025-0032591

(51) Int. Cl. H01F 17/00

(52) U.S. Cl. CPC H01F 17/0006; H01F 2017/008

(57) ABSTRACT

Provided is a coil component comprising: a body having a first surface, a second surface opposing the first surface in a first direction, and a third surface connecting the first surface to the second surface, and including a first metallic magnetic particle; a coil disposed in the body and having one end extending to the third surface of the body; a connection portion connected to the one end of the coil and extending to the first surface of the body; and a shielding layer disposed on the third surface of the body and on the connection portion, and including a second metallic magnetic particle, wherein at least a portion of the first metallic magnetic particle extends to the third surface of the body, and at least a portion of the first metallic magnetic particle extending to the third surface of the body includes a cut surface.

### CROSS-REFERENCE TO RELATED APPLICATIONS

This application claims benefit of priority to Korean Patent Application No. 10-2025-0032591 filed on Mar 13, 2025 in the Korean Intellectual Property Office, the disclosure of which is incorporated herein by reference in its entirety.

### TECHNICAL FIELD

The present disclosure relates to a coil component.

Among coil components, an inductor is a representative passive electronic component used in electronic devices, together with a resistor and a capacitor.

As electronic devices become increasingly high-performance and compact, the number of electronic components used in the electronic device may increase and their sizes may decrease.

As the coil component becomes thinner and smaller, an inductor having a bottom-electrode structure is widely used. In the case of an inductor having a bottom-electrode structure, an internal coil and an electrode on a bottom surface of the component may be connected to each other through a connection electrode disposed on an exterior of a component body. The connection electrode disposed on the exterior of the body may cause an electrical side effect such as electromagnetic interference (EMI) radiation or a coupling effect between adjacent chips after being mounted, and it may be difficult to suppress radiation characteristics even when an insulating layer is applied thereon.

### SUMMARY

An aspect of the present disclosure is to provide a coil component capable of improving an electrical side effect that may occur due to a connection electrode.

Another aspect of the present disclosure is to provide a coil component capable of controlling a plating spread phenomenon during external electrode plating.

According to an aspect of the present disclosure, a coil component includes: a body having a first surface, a second surface opposing the first surface in a first direction, and a third surface connecting the first surface to the second surface, and including a first metallic magnetic particle; a coil disposed in the body and having one end extending to the third surface of the body; a connection portion connected to the one end of the coil and extending to the first surface of the body; and a shielding layer disposed on the third surface of the body and on the connection portion, and including a second metallic magnetic particle, wherein at least a portion of the first metallic magnetic particle extends to the third surface of the body, and at least a portion of the first metallic magnetic particle extending to the third surface of the body includes a cut surface.

According to another aspect of the present disclosure, a coil component includes: a body having a first surface, a second surface opposing the first surface in a first direction, and a third surface connecting the first surface to the second surface, and including a first metallic magnetic particle; a groove formed in the third surface of the body and including an inner surface positioned inside the body relative to the third surface; a coil disposed in the body and having one end extending to the third surface of the body; a connection portion connected to the one end of the coil and extending to the first surface of the body; and a shielding layer disposed on the third surface of the body and on the connection portion, and including a second metallic magnetic particle, wherein the shielding layer fills at least a portion of the groove.

According to another aspect of the present disclosure, a coil component includes: a body having a first surface, a second surface opposing the first surface in a first direction, and a third surface connecting the first surface to the second surface, and including a first metallic magnetic particle; a coil disposed in the body and having one end extending to the third surface of the body; a connection portion connected to the one end of the coil and extending to the first surface of the body; and a shielding layer disposed on the third surface of the body and on the connection portion, and including a second metallic magnetic particle, wherein the third surface of the body and the shielding layer form a discontinuous interface.

According to another aspect of the present disclosure, a coil component includes: a body having a first surface, a second surface opposing the first surface in a first direction, and a third surface connecting the first surface to the second surface, and including a first metallic magnetic particle; a coil disposed in the body and having one end extending to the third surface of the body; a connection portion connected to the one end of the coil and extending to the first surface of the body; and a shielding layer disposed on the third surface of the body and on the connection portion, and including a second metallic magnetic particle, wherein an average particle size of the first metallic magnetic particle is larger than an average particle size of the second metallic magnetic particle.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first exemplary embodiment of the present disclosure;

FIG. 2 is a perspective view illustrating the coil component according to a first exemplary embodiment of the present disclosure as viewed from the bottom;

FIG. 3 is a perspective view illustrating a state where a shielding layer is omitted from FIG. 2;

FIG. 4 is a perspective view illustrating a state where an external electrode is omitted from FIG. 3;

FIG. 5 is a cross-sectional view taken along line I-I′ in FIG. 1;

FIG. 6 is a cross-sectional view taken along line II-II′ in FIG. 1;

FIG. 7 is an enlarged view of portion A in FIG. 6;

FIG. 8 is a cross-sectional view taken along line III-III′ in FIG. 1;

FIG. 9 is a cross-sectional view illustrating a modified example of FIG. 7;

FIG. 10 is a cross-sectional view illustrating a modified example of FIG. 6;

FIG. 11 is a cross-sectional view illustrating another modified example of FIG. 6;

FIG. 12 is a cross-sectional view illustrating a modified example of FIG. 8;

FIG. 13 is a perspective view schematically illustrating a coil component according to a second exemplary embodiment of the present disclosure;

FIG. 14 is a perspective view illustrating the coil component according to a second exemplary embodiment of the present disclosure as viewed from the bottom;

FIG. 15 is a perspective view illustrating a state where a shielding layer is omitted from FIG. 14;

FIG. 16 is a perspective view illustrating a state where an external electrode is omitted from FIG. 15;

FIG. 17 is a cross-sectional view taken along line IV-IV′ in FIG. 13;

FIG. 18 is a cross-sectional view taken along line V-V′ in FIG. 13;

FIG. 19 is an enlarged view of portion B in FIG. 18;

FIG. 20 is a cross-sectional view illustrating a modified example of FIG. 19;

FIG. 21 is a cross-sectional view illustrating a modified example of FIG. 18;

FIG. 22 is a cross-sectional view illustrating another modified example of FIG. 18;

FIG. 23 is a cross-sectional view illustrating another modified example of FIG. 18;

FIG. 24 is a perspective view schematically illustrating a coil component according to a third exemplary embodiment of the present disclosure;

FIG. 25 is a perspective view schematically illustrating a coil component according to a fourth exemplary embodiment of the present disclosure; and

FIG. 26 is a perspective view schematically illustrating a coil component according to a fifth exemplary embodiment of the present disclosure.

### DETAILED DESCRIPTION

Terms used in this application are merely used to describe specific exemplary embodiments rather than limit the scope of the present disclosure. A term of a singular number may include its plural number unless explicitly indicated otherwise in the context. It should be understood that in this application, terms such as “include” or “have” indicate that the presence of the features, numbers, steps, operations, components, parts, or combinations thereof, which are described in the specification, and do not preclude the presence or addition of one or more other features, numbers, steps, operations, components, parts, or combinations thereof. In addition, throughout the specification, the term “on” refers to being positioned on/above or beneath/below a target portion and does not necessarily refer to being positioned on an upper side of the target portion in a gravity-direction.

In addition, in a contact relationship between respective components, the term “couple” is used as a concept encompassing not only a case in which the respective components are physically in direct contact with each other, but also a case in which another component is interposed between the respective components and each of the components is in contact with the interposed component.

The sizes and thicknesses of respective structures shown in the drawings are arbitrarily illustrated for convenience of description, and the present disclosure is not necessarily limited to the illustrated structures.

Here and throughout the specification and claims, range limitations are combined and/or interchanged. Such ranges are identified and include all the sub-ranges contained therein unless context or language indicates otherwise. For example, all ranges disclosed herein are inclusive of the endpoints, and the endpoints are independently combinable with each other.

Approximating language, as used herein throughout the specification and claims, may be applied to modify any quantitative representation that could permissibly vary without resulting in a change in the basic function to which it is related. Accordingly, a value solidified by a term or terms, such as “about”, and “substantially” is not to be limited to the precise value specified.

In the drawings, an X-direction may be defined as a first direction or a thickness direction, a Y-direction may be defined as a second direction or a length direction, and a Z-direction may be defined as a third direction or a width direction.

Hereinafter, a coil component according to an exemplary embodiment of the present disclosure will be described in detail with reference to the accompanying drawings. In describing the present disclosure with reference to the accompanying drawings, the same reference numerals are assigned to the same or corresponding elements and redundant descriptions thereof will be omitted.

Various types of electronic components are used in electronic devices, and various types of coil components may be appropriately used among these electronic components for the purpose of noise removal or the like.

That is, in an electronic device, a coil component may be used as a power inductor, a high-frequency (HF) inductor, a general bead, a high-frequency bead (GHz Bead), a common mode filter, or the like.

### First exemplary embodiment

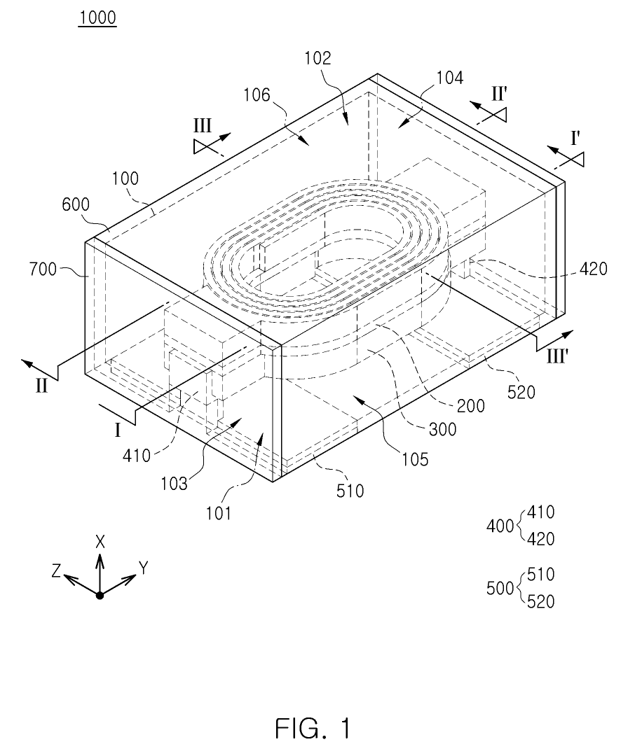

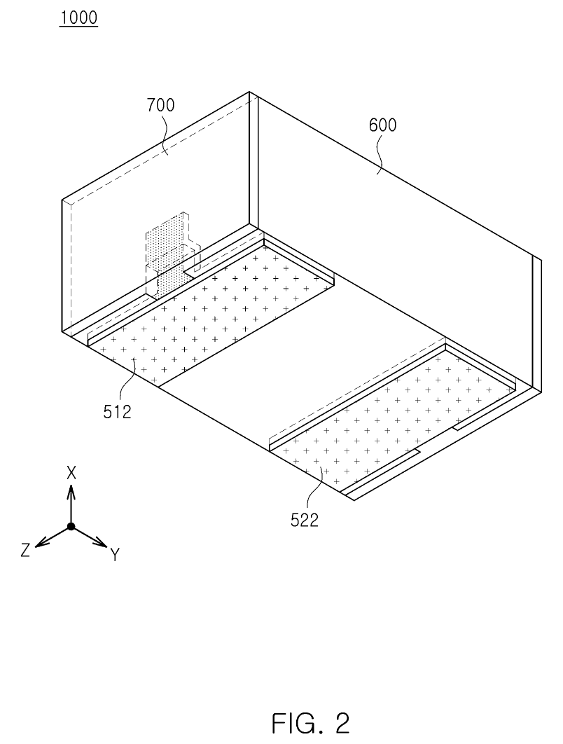

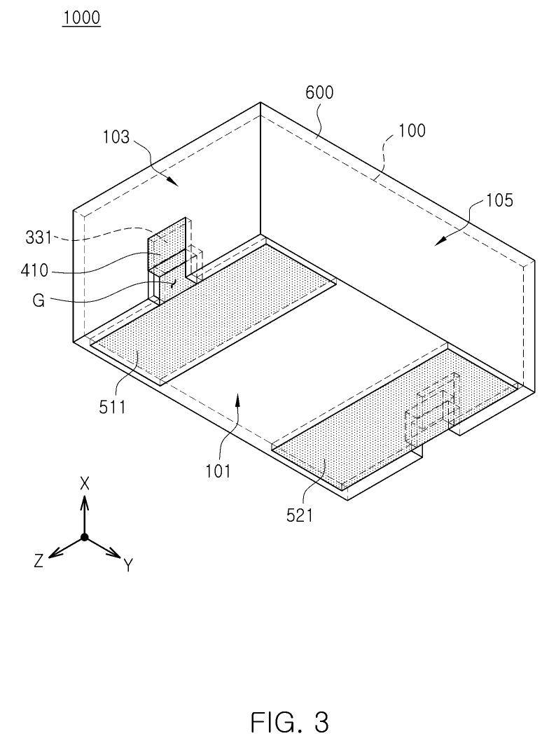

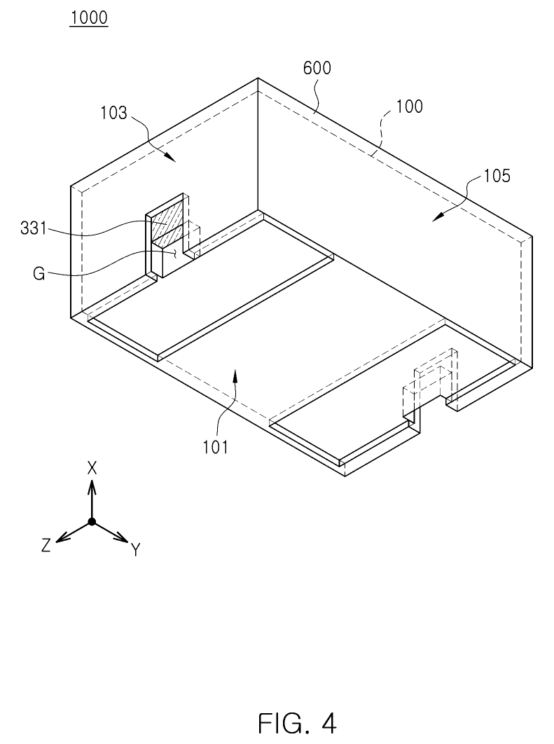

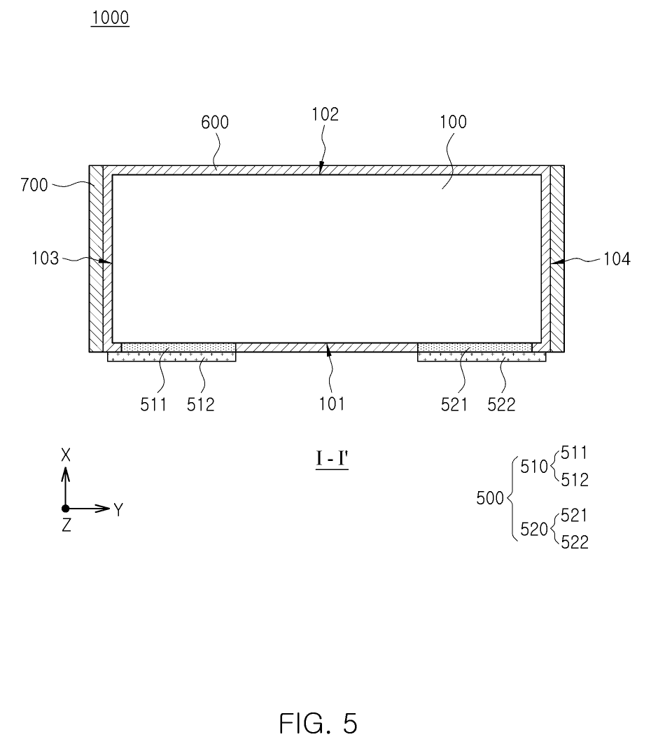

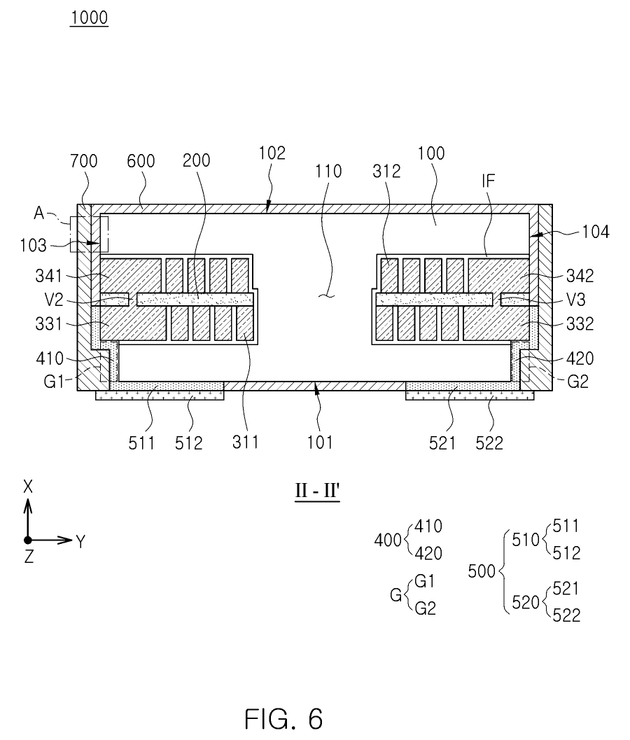

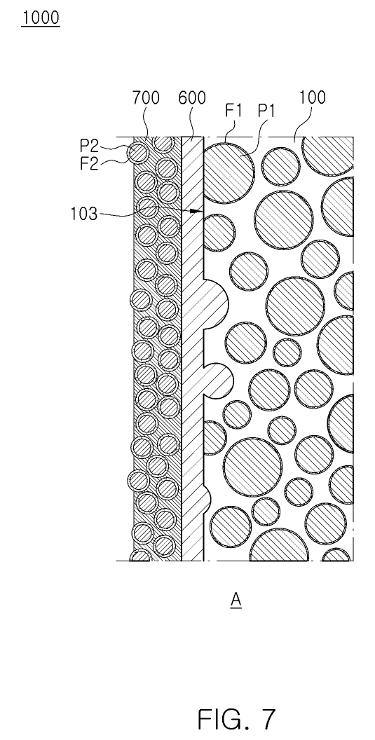

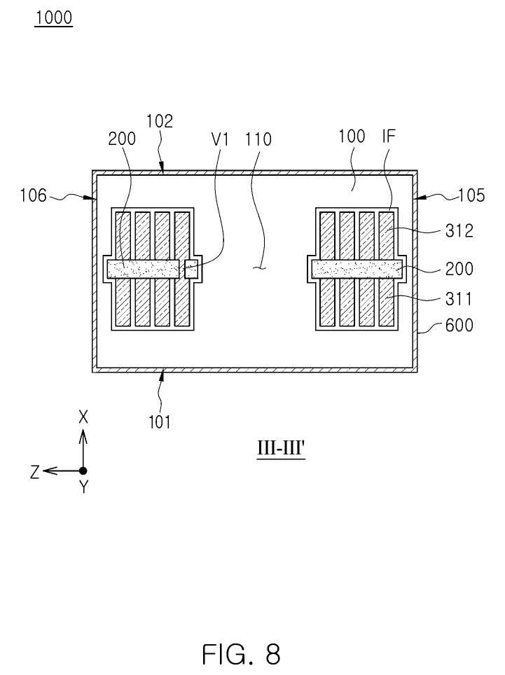

FIG. 1 is a perspective view schematically illustrating a coil component according to a first exemplary embodiment of the present disclosure. FIG. 2 is a view illustrating the coil component according to a first exemplary embodiment of the present disclosure as viewed from the bottom. FIG. 3 is a view illustrating a state where a shielding layer is omitted from FIG. 2. FIG. 4 is a view illustrating a state where an external electrode is omitted from FIG. 3. FIG. 5 is a cross-sectional view taken along line I-I' in FIG. 1. FIG. 6 is a cross-sectional view taken along line II-II' in FIG. 1. FIG. 7 is an enlarged view of portion A in FIG. 6. FIG. 8 is a cross-sectional view taken along line III-III′ in FIG. 1.

Referring to FIGS. 1 to 8, a coil component 1000 according to a first exemplary embodiment of the present disclosure may include a body 100, a support member 200, a coil 300, a connection portion 400, an external electrode 500, a first insulating layer 600, and a shielding layer 700, and may further include a coil insulating film IF.

The body 100 may form an exterior of the coil component 1000 according to this exemplary embodiment, and the coil 300 and the support member 200 may be disposed therein.

The body 100 may be formed in a substantially hexahedral shape.

As illustrated in FIG. 1, the body 100 may have a first surface 101 and a second surface 102 opposing each other in the X-direction (i.e., the first direction), a third surface 103 and a fourth surface 104 opposing each other in the Y-direction (i.e., the second direction), and a fifth surface 105 and a sixth surface 106 opposing each other in the Z-direction (i.e., the third direction). Each of the third to sixth surfaces 103, 104, 105, and 106 of the body 100 corresponds to a side surface of the body 100 that connects the first and second surfaces 101 and 102 of the body 100 to each other.

For example, the body 100 may be formed such that the coil component 1000 according to this exemplary embodiment, in which the external electrode 500 and the first insulating layer 600 to be described below are formed, has a length of 2.0 mm, a width of 1.2 mm, and a thickness of 0.65 mm. However, the body 100 is not limited thereto.

As a magnetic material, the body 100 may include a first metallic magnetic particle P1. In an example, the body 100 may be formed by stacking one or more magnetic composite sheets in each of which the first metallic magnetic particle P1 is dispersed in a resin.

The first metallic magnetic particle P1 may include at least one selected from the group consisting of iron (Fe), silicon (Si), chromium (Cr), cobalt (Co), molybdenum (Mo), aluminum (Al), niobium (Nb) copper (Cu), and nickel (Ni). For example, the first metallic magnetic particle P1 may be at least one of a pure iron powder, an Fe-Si-based alloy powder, an Fe-Si-Al-based alloy powder, an Fe-Ni-based alloy powder, an Fe-Ni-Mo-based alloy powder, an Fe-Ni-Mo-Cu-based alloy powder, an Fe-Co-based alloy powder, an Fe-Ni-Co-based alloy powder, an Fe-Cr-based alloy powder, an Fe-Cr-Si-based alloy powder, an Fe-Si-Cu-Nb-based alloy powder, an Fe-Ni-Cr-based alloy powder, and an Fe-Cr-Al-based alloy powder.

The first metallic magnetic particle P1 may be amorphous or crystalline. For example, the first metallic magnetic particle P1 may be an Fe-Si-B-Cr-based amorphous alloy powder. However, the first metallic magnetic particle P1 is not necessarily limited thereto.

However, the body 100 may have a structure other than a structure in which the first metallic magnetic particle P1 is dispersed in a resin. For example, the body 100 may include ferrite.

The ferrite may be, for example, at least one of spinel ferrites such as magnesium–zinc (Mg–Zn), manganese–zinc (Mn–Zn), manganese–magnesium (Mn–Mg), copper–zinc (Cu–Zn), magnesium–manganese–strontium (Mg–Mn–Sr), and nickel–zinc (Ni–Zn) systems; hexagonal ferrites such as barium–zinc (Ba–Zn), barium–magnesium (Ba–Mg), barium–nickel (Ba–Ni), barium–cobalt (Ba–Co), and barium–nickel–cobalt (Ba–Ni–Co) systems; garnet ferrites such as yttrium (Y) systems; and lithium (Li)-based ferrites.

The metallic magnetic particle P1 may have an average diameter ranging from about 0.1 μm to 30 μm. However, the metallic magnetic particle P1 is not limited thereto.

The first metallic magnetic particle P1 may include an insulating film F1. The insulating film F1 may be formed on a surface of the first metallic magnetic particle P1. The insulating film F1 may include, for example, epoxy, polyimide, or a liquid crystal polymer alone or in combination, or may include silica (SiO₂) or alumina (Al₂O₃), or may be an oxide film including a metal included in the first metallic magnetic particle P1.

The body 100 may include two or more types of the first metallic magnetic particle P1 dispersed in a resin. Here, the first metallic magnetic particle of different types indicates that the first metallic magnetic particles are distinguished from each other based on any one of an average diameter, a composition, a crystallinity, and a shape.

The resin may include epoxy, polyimide, or a liquid crystal polymer alone or in combination. However, the resin is not limited thereto.

The body 100 may include a core 110 penetrating the coil 300 and the support member 200 to be described below. The core 110 may be formed by filling a through-hole through which a magnetic composite sheet penetrates central portions of the coil 300 and the support member 200, respectively. However, the core 110 is not limited thereto.

Referring to FIG. 7, at least a portion of the first metallic magnetic particle P1 may extend to the third surface 103 of the body 100. At least a portion of the first metallic magnetic particle P1 extending to the third surface 103 of the body 100 may include a cut surface. The cut surface may be in direct contact with the first insulating layer 600 to be described below. In addition, a portion of the first metallic magnetic particle P1 extending to the third surface 103 of the body 100 may fall off, and the first insulating layer 600 to be described below may fill a portion where the first metallic magnetic particle P1 is fallen off. The third surface 103 of the body 100 may be cut during a process of individualizing the coil components. Specifically, at a coil bar level, which is a state before each coil component is individualized, dicing may be performed on one surface of a coil bar along a boundary line coinciding with the width direction of each coil component. Due to the dicing, the first metallic magnetic particle P1 may have a cut surface or may fall off.

Similarly, the fourth surface 104 of the body 100 may also be cut during the process of individualizing the coil components, and at least a portion of the first metallic magnetic particle P1 extending to the fourth surface 104 of the body 100 may include a cut surface. Detailed descriptions thereof are omitted in order to avoid redundancy.

Referring to FIGS. 3 and 4, a groove G may be formed on the third surface 103 of the body 100. The groove G may be formed by removing a portion of the first insulating layer 600 and the body 100 by a laser etching process.

The groove G may be formed at an edge between the third surface 103 and the first surface 101. A depth of the groove G may be formed such that a lead-out portion 331 to be described below is exposed to an inner surface of the groove G. However, the groove G does not extend to the second surface 102. That is, the groove G does not penetrate through the body 100 in the first direction (i.e., the X-direction).

The groove G may not extend to the fifth surface 105 or the sixth surface 106. That is, the groove G may be formed to have a length smaller than a length of the body 100 in the third direction (i.e., the Z-direction). In this case, a connection structure between the coil 300 and the external electrode 500 may be formed while minimizing magnetic loss.

Meanwhile, the inner surface of the groove G may also form a surface of the body 100. However, in the specification, for convenience of description, the inner surface of the groove G is distinguished from the surface of the body 100.

Referring to FIG. 4, the groove G may include an inner surface positioned inside the body 100 relative to the third surface 103 of the body 100. Specifically, the groove G is illustrated as having inner walls parallel to the third surface 103 and the fourth surface 104 and a bottom parallel to the first surface 101 and the second surface 102, which is provided for convenience of description, and the scope of this exemplary embodiment is not limited thereto. For example, the groove G may be formed to have an inner surface having a curved shape connecting the third surface 103 and the first surface 101 of the body 100 to each other based on a Y-X cross-section (i.e., a second-direction–first-direction cross-section) of the coil component 1000 according to this exemplary embodiment. However, in the specification, for convenience of description, the groove G will be described as having the inner walls and the bottom.

The lead-out portions 331 may be exposed to the bottom of the groove G. As described below, the lead-out portions 331 may be connected to the external electrode 500 through the connection portion 400 disposed on the bottom and inner walls of the groove G. In addition, the shielding layer 700 may be disposed on the connection portion 400 to fill at least a portion of the groove G. Detailed descriptions thereof are provided hereinafter in descriptions of the lead-out portions 331, the connection portion 400, and the shielding layer 700.

Meanwhile, referring to FIG. 6, the groove G may also be formed on the fourth surface 104, and specifically, may be formed at an edge between the fourth surface 104 and the first surface 101. When the groove G is formed on the third surface 103 and the fourth surface 104, for convenience, the groove formed in the third surface 103 may be referred to as a first groove G1, and the groove formed in the fourth surface 104 may be referred to as a second groove G2.

The support member 200 may be disposed in the body 100 and may support the coil 300 to be described below.

The support member 200 may be made of an insulating material including a thermosetting insulating resin such as epoxy resin, a thermoplastic insulating resin such as polyimide, or a photosensitive insulating resin, or may be made of an insulating material in which a reinforcing material such as a glass fiber or an inorganic filler is impregnated in the insulating resin. For example, the support member 200 may be made of an insulating material such as prepreg, Ajinomoto Build-up Film (ABF), FR-4, Bismaleimide Triazine (BT) resin, or Photo Imagable Dielectric (PID). However, the support member 200 is not limited thereto.

As the inorganic filler, at least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

When the support member 200 is made of an insulating material including the reinforcing material, the support member 200 may provide better rigidity. When the support member 200 is made of an insulating material not including the glass fiber, the support member 200 is advantageous for reducing a thickness of the coil component 1000 according to this exemplary embodiment. In addition, based on the same size of the body 100, a volume occupied by the coil 300 and/or the magnetic material may be increased to improve part characteristics. When the support member 200 is made of an insulating material including the photosensitive insulating resin, the number of processes for forming the coil 300 may be reduced, which is advantageous for reducing production costs, and minute vias may be formed.

The coil 300 may be disposed in the body 100 and exhibit characteristics of the coil component. For example, when the coil component 1000 according to this exemplary embodiment is used as a power inductor, the coil 300 may store an electric field as a magnetic field to maintain an output voltage, thereby stabilizing a power supply of an electronic device.

Referring to FIGS. 6 and 8, the coil 300 may include coil patterns 311 and 312, lead-out portions 331 and 332, auxiliary lead-out portions 341 and 342, and vias V1, V2, and V3. Specifically, as illustrated in FIG. 6, the first coil pattern 311, the first lead-out portion 331, and the second lead-out portion 332 may be disposed on a lower surface of the support member 200 opposing the first surface 101 of the body 100, and the second coil pattern 312, the first auxiliary lead-out portion 341, and the second auxiliary lead-out portion 342 may be disposed on an upper surface of the support member 200. On the lower surface of the support member 200, the first coil pattern 311 may be in contact with and connected to the first lead-out portion 331, and each of the first coil pattern 311 and the first lead-out portion 331 may be spaced apart from the second lead-out portion 332. On the upper surface of the support member 200, the second coil pattern 312 may be in contact with and connected to the second auxiliary lead-out portion 342, and the second coil pattern 312 and the second auxiliary lead-out portion 342 may be spaced apart from the first auxiliary lead-out portion 341. The first via V1 may penetrate through the support member 200 to be in contact with and connected to the first coil pattern 311 and the second coil pattern 312, respectively. The second via V2 may penetrate through the support member 200 to be in contact with and connected to the first lead-out portion 331 and the first auxiliary lead-out portion 341, respectively. The third via V3 may penetrate through the support member 200 to be in contact with and connected to the second lead-out portion 332 and the second auxiliary lead-out portion 342, respectively. In this manner, the coil 300 may function as a single integrated coil.

Each of the first coil pattern 311 and the second coil pattern 312 may have the form of a planar spiral forming at least one turn while having the core 110 as an axis. For example, the first coil pattern 311 may form at least one turn while having the core 110 as an axis on the lower surface of the support member 200.

Referring to FIG. 4, the lead-out portions 331 may be exposed to the bottom of the groove G. The connection portion 400 to be described below may be disposed in the groove G, and the coil 300 may thus be connected to the external electrode 500 through the connection portion 400. Similarly, the second lead-out portion 332 may be exposed to the bottom of the second groove G2.

The lead-out portions 331 and 332 and the auxiliary lead-out portions 341 and 342 may be exposed to the third and fourth surfaces 103 and 104 of the body 100, respectively. That is, the first lead-out portion 331 may be exposed to the third surface 103 of the body 100, and the second lead-out portion 332 may be exposed to the fourth surface 104 of the body 100. The first auxiliary lead-out portion 341 may be exposed to the third surface 103 of the body 100, and the second auxiliary lead-out portion 342 may be exposed to the fourth surface 104 of the body 100. As illustrated in FIG. 6, the first lead-out portion 331 may be continuously exposed to the bottom of the first groove G1 and the third surface 103, and the second lead-out portion 332 may be continuously exposed to the bottom of the second groove G2 and the fourth surface 104.

At least one of the coil patterns 311 and 312, the vias V1, V2, and V3, the lead-out portions 331 and 332, and the auxiliary lead-out portions 341 and 342 may include at least one conductive layer.

For example, when the second coil pattern 312, the auxiliary lead-out portions 341 and 342, and the vias V1, V2, and V3 are formed by plating on the upper surface side of the support member 200, each of the second coil pattern 312, the auxiliary lead-out portions 341 and 342, and the vias V1, V2, and V3 may include a seed layer and an electroplated layer. Here, the electroplated layer may have a single-layer structure or may have a multilayer structure. The electroplated layer having the multilayer structure may be formed as a conformal film structure in which another electroplated layer is formed along a surface of one electroplated layer or may be formed in a shape in which another electroplated layer is stacked only on one surface of one electroplated layer. The seed layer may be formed by using an electroless plating method or a vapor deposition method such as sputtering. The seed layer of the second coil pattern 312, the seed layers of the auxiliary lead-out portions 341 and 342, and the seed layers of the vias V1, V2, and V3 may be integrally formed not to have boundaries therebetween. However, the seed layer is not limited thereto. The electroplated layer of the second coil pattern 312, the electroplated layers of the auxiliary lead-out portions 341 and 342, and the electroplated layers of the vias V1, V2, and V3 may be integrally formed not to have boundaries therebetween. However, the electroplated layer is not limited thereto.

In another example, the coil 300 is formed by separately forming the first coil pattern 311 and the lead-out portions 331 and 332 adjacent to the lower surface of the support member 200 and the second coil pattern 312 and the auxiliary lead-out portions 341 and 342 adjacent to the upper surface of the support member 200, and then collectively stacking the same on the support member 200. In such an example, the vias V1, V2, and V3 may include a high-melting-point metal layer and a low-melting-point metal layer having a melting point lower than a melting point of the high-melting-point metal layer. Here, the low-melting-point metal layer may be made of a solder including lead (Pb) and/or tin (Sn). At least a portion of the low-melting-point metal layer may be melted due to pressure and temperature during collective stacking, and, for example, an intermetallic compound (IMC) layer may be formed at a boundary between the low-melting-point metal layer and the second coil pattern 312.

For example, as illustrated in FIG. 6, the coil patterns 311 and 312, the lead-out portions 331 and 332, the auxiliary lead-out portions 341 and 342, and the vias V1, V2, and V3 may be formed to protrude respectively from the lower and upper surfaces of the support member 200. In another example, the first coil pattern 311 and the lead-out portions 331 and 332 may be formed to protrude from the lower surface of the support member 200, and the second coil pattern 312 and the auxiliary lead-out portions 341 and 342 may be embedded in the upper surface of the support member 200 to allow the upper surfaces thereof to be exposed to the upper surface of the support member 200. In this case, a recess may be formed on an upper surface of the second coil pattern 312 and/or on upper surfaces of the auxiliary lead-out portions 341 and 342 to prevent the upper surface of the support member 200 and the upper surface of the second coil pattern 312 and/or the upper surface of the auxiliary lead-out portions 341 and 342 from being positioned on the same plane.

Each of the coil patterns 311 and 312, the lead-out portions 331 and 332, the auxiliary lead-out portions 341 and 342, and the vias V1, V2, and V3 may be made of a conductive material such as copper (Cu), aluminum (Al), silver (Ag), tin (Sn), gold (Au), nickel (Ni), lead (Pb), titanium (Ti), chromium (Cr), or an alloy thereof. However, each component is not limited thereto.

Meanwhile, the first auxiliary lead-out portion 341 is irrelevant to electrical connection of remaining configurations of the coil 300, and the first auxiliary lead-out portion 341 and the second via V2 may thus be omitted in this exemplary embodiment.

The connection portion 400 may be connected to one end of the coil and extend to the first surface 101 of the body 100. The connection portion 400 may be connected to the lead-out portions 331 and 332 of the coil and may extend to the first surface 101 of the body 100 to be connected to the external electrode 500.

The connection portion 400 may be disposed on the inner surface of the groove G. Here, the inner surface of the groove G may be positioned inside the component relative to the third surface 103 or the fourth surface 104 of the body 100, and the coil component according to this exemplary embodiment may thus implement the connection portion 400 inward relative to the third surface 103 of the body 100.

In addition, a length of the connection portion 400 in the third direction (i.e., the Z-direction) may be smaller than a length of the body 100 in the third direction (i.e., the Z-direction). Specifically, when the length of the connection portion 400 in the third direction (i.e., the Z-direction) is referred to as a and the length of the body 100 in the third direction (i.e., the Z-direction) is referred to as b, a/b may satisfy a range of 0.05 to 0.7.

As described above, electromagnetic interference (EMI) radiation originating from the connection portion 400 may be reduced by implementing the connection portion 400 inward relative to the body side surface and reducing a formation area of the connection portion 400.

The connection portion 400 may include a first connection portion 410 and a second connection portion 420.

Referring to FIG. 6, the first connection portion 410 may be connected to the first lead-out portion 331 and may be connected to a first external electrode 510. The first connection portion 410 may be disposed on the bottom of the first groove G1 and may be connected to the first lead-out portion 331 exposed to the bottom of the first groove G1. The first connection portion 410 may extend along an inner wall of the first groove G1 and may be connected to the first external electrode 510.

Similarly, the second connection portion 420 may be connected to the second lead-out portion 332 and may be connected to a second external electrode 520. The second connection portion 420 may be disposed on the bottom of the second groove G2 and may be connected to the second lead-out portion 332 exposed to the bottom of the second groove G2. The second connection portion 420 may extend along an inner wall of the second groove G2 and may be connected to the second external electrode 520.

The connection portion 400 may be formed by forming the groove G by removing portions of the first insulating layer 600 and the body 100 by a laser etching process, and then by performing a plating process using the first insulating layer 600 as a plating resist. The connection portion 400 may be formed in the form of a conformal film along the bottom and inner wall of the groove G.

The connection portion 400 may be made of a conductive material such as copper (Cu), aluminum (Al), silver (Ag), tin (Sn), gold (Au), nickel (Ni), lead (Pb)), chromium (Cr), titanium (Ti), or an alloy thereof. However, the connection portion 400 is not limited thereto.

The external electrode 500 may be disposed on the first surface 101 of the body 100 and may be connected to the connection portion 400. The external electrode 500 may include the first external electrode 510 and the second external electrode 520 spaced apart from each other on the first surface 101 of the body 100 in the second direction (i.e., the Y-direction).

The first external electrode 510 may be connected to the first lead-out portion 331 through the first connection portion 410. The first external electrode 510 may include a first layer 511 and a second layer 512. The first layer 511 may be disposed on the first surface 101 and may be connected to the first connection portion 410. The first layer 511 and the first connection portion 410 may be formed together in the same process and may be formed integrally. That is, a boundary between the first layer 511 and the first connection portion 410 may not be formed.

The second layer 512 may be disposed on the first layer 511. The second layer 512 may be formed as a single layer or a plurality of layers. For example, the second layer 512 may include a nickel (Ni) plating layer and a tin (Sn) plating layer including nickel (Ni) and tin (Sn), respectively. However, the second layer 512 is not limited thereto.

The second external electrode 520 may be connected to the second lead-out portion 332 through the second connection portion 420. The second external electrode 520 may include a first layer 521 and a second layer 522. The first layer 521 may be disposed on the first surface 101 and may be connected to the second connection portion 420. The first layer 521 and the second connection portion 420 may be formed together in the same process and may be formed integrally. That is, a boundary between the first layer 521 and the second connection portion 420 may not be formed.

The second layer 522 may be disposed on the first layer 521. The second layer 522 may be formed as a single layer or a plurality of layers. For example, the second layer 522 may include a nickel (Ni) plating layer and a tin (Sn) plating layer including nickel (Ni) and tin (Sn), respectively. However, the second layer 522 is not limited thereto.

The external electrode 500 may be formed by a vapor deposition method such as sputtering and/or a plating method. However, the external electrode 500 is not limited thereto. The external electrode 500 may be made of a conductive material such as copper (Cu), aluminum (Al), silver (Ag), tin (Sn), gold (Au), nickel (Ni), lead (Pb), chromium (Cr), titanium (Ti), or an alloy thereof. However, the external electrode 500 is not limited thereto.

The first insulating layer 600 may be disposed on the surface of the body 100 to prevent the body 100 from being exposed outward of the coil component. The first insulating layer 600 may be disposed on the first to sixth surfaces 101, 102, 103, 104, 105, and 106 of the body 100.

The first insulating layer 600 may be disposed on the third surface 103 of the body 100. The first insulating layer 600 may be disposed between the third surface 103 of the body 100 and the shielding layer 700. Referring to FIG. 7, the first insulating layer 600 may be in contact with the cut surface of the first metallic magnetic particle P1 and may fill a portion where the first metallic magnetic particle P1 is fallen off.

Referring to FIG. 6, at least a portion of the first insulating layer 600 disposed on the third surface 103 may be removed by a laser etching process. Accordingly, the shielding layer 700 may fill at least a portion of the groove G and may be disposed directly on the connection portion 400.

Meanwhile, the first insulating layer 600 is a configuration that may be omitted relative to the third surface 103 and the fourth surface 104 of the body 100. That is, the first insulating layer 600 may be removed after the connection portion 400 is formed, and the shielding layer 700 to be described below may be disposed directly on the third surface 103 and the fourth surface 104. Descriptions thereof will be provided in a second exemplary embodiment.

The first insulating layer 600 may be disposed on the first surface 101 of the body 100 and may expose the first layer 511 of the external electrode 500.

The first insulating layer 600 may be formed in a state where each coil component is individualized. For example, the first insulating layer 600 may be formed after the above-described dicing process.

After the coil components are individualized, the first insulating layer 600 may be formed on an entire surface of the body 100 by performing drum coating, screen printing, or inkjet printing on each coil component. Regions for forming the connection portion 400 and the external electrode 500 may then be etched using a process such as laser etching. That is, before the external electrode 500 is formed, the first insulating layer 600 may be disposed on the surface of the body 100, and the first insulating layer 600 may function as a mask in forming the connection portion 400 and the external electrode 500 by plating or the like.

The first insulating layer 600 may include a thermoplastic resin such as a polystyrene-based resin, a vinyl acetate-based resin, a polyester-based resin, a polyethylene-based resin, a polypropylene-based resin, a polyamide-based resin, a rubber-based resin, or an acrylic-based resin, a thermosetting resin such as a phenol-based resin, an epoxy-based resin, a urethane-based resin, a melamine-based resin, or an alkyd-based resin, a photosensitive resin, parylene, silicon oxide (SiOₓ), or silicon nitride (SiNₓ). The first insulating layer 600 may further include an insulating filler such as an inorganic filler and is not limited thereto.

Referring to FIGS. 6 and 7, the shielding layer 700 may be disposed on the third surface 103 of the body 100 and on the connection portion 400, and may include a second metallic magnetic particle P2.

The shielding layer 700 may be disposed on the third surface 103 and the fourth surface 104 of the body 100. Referring to FIG. 6, the shielding layer 700 may be disposed on the first insulating layer 600 disposed on the third surface 103 and the fourth surface 104. Here, “being disposed on the third surface 103” includes not only a case of being disposed directly on the third surface 103 but also a case of being disposed on the first insulating layer 600 disposed on the third surface 103.

In an inductor having a bottom-electrode structure, an internal coil and an electrode on a bottom surface of the component may be connected to each other through a connection electrode disposed on an exterior of a component body. The connection electrode disposed on the exterior of the body may cause an electrical side effect such as electromagnetic interference (EMI) radiation or a coupling effect between adjacent chips after being mounted, and it may be difficult to suppress radiation characteristics even when an insulating layer is applied thereon.

The shielding layer 700 may cover the connection portion 400 and may fill at least a portion of the groove G. In this case, as described above, the shielding layer 700 may include the second metallic magnetic particle P2. That is, the coil component according to this exemplary embodiment may reduce the side effect such as the EMI radiation caused by the connection portion 400 by covering the connection portion 400 with the shielding layer 700 including the metallic magnetic particle P2.

The shielding layer 700 may include an inner surface in contact with the first insulating layer 600 and the connection portion 400 and an outer surface opposing the inner surface in the second direction (i.e. the Y-direction).

An average thickness of the shielding layer 700 may satisfy a range of 5 μm to 100 μm. When the average thickness of the shielding layer 700 is less than 5 μm, a shielding effect may be insufficient, and when the average thickness exceeds 100 μm, a size of the body 100 for implementing electrical performance of the coil component may be reduced. The average thickness of the shielding layer 700 may be obtained by measuring a distance between the inner surface and the outer surface (or its length along the second direction), and, more specifically, may be measured based on the inner surface of the shielding layer 700 that is in contact with the inner wall of the groove G. The average thickness of the shielding layer 700 may indicate an average value of values measured multiple times.

As a magnetic material, the shielding layer 700 may include the second metallic magnetic particle P2. In an example, the shielding layer 700 may be formed by stacking magnetic composite sheets in each of which the second metallic magnetic particle P2 is dispersed in a resin.

The second metallic magnetic particle P2 may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the second metallic magnetic particle P2 may be at least one of a pure iron powder, an Fe-Si-based alloy powder, an Fe-Si-Al-based alloy powder, an Fe-Ni-based alloy powder, an Fe-Ni-Mo-based alloy powder, an Fe-Ni-Mo-Cu-based alloy powder, an Fe-Co-based alloy powder, an Fe-Ni-Co-based alloy powder, an Fe-Cr-based alloy powder, an Fe-Cr-Si-based alloy powder, an Fe-Si-Cu-Nb-based alloy powder, an Fe-Ni-Cr-based alloy powder, and an Fe-Cr-Al-based alloy powder.

The second metallic magnetic particle P2 may be amorphous or crystalline. For example, the second metallic magnetic particle P2 may be an Fe-Si-B-Cr-based amorphous alloy powder. However, the second metallic magnetic particle P2 is not necessarily limited thereto.

However, the shielding layer 700 may have a structure other than a structure in which the second metallic magnetic particle P2 is dispersed in a resin. For example, the shielding layer 700 may include ferrite.

The ferrite may be, for example, at least one of spinel ferrites such as magnesium–zinc (Mg–Zn), manganese–zinc (Mn–Zn), manganese–magnesium (Mn–Mg), copper–zinc (Cu–Zn), magnesium–manganese–strontium (Mg–Mn–Sr), and nickel–zinc (Ni–Zn) systems; hexagonal ferrites such as barium–zinc (Ba–Zn), barium–magnesium (Ba–Mg), barium–nickel (Ba–Ni), barium–cobalt (Ba–Co), and barium–nickel–cobalt (Ba–Ni–Co) systems; garnet ferrites such as yttrium (Y) systems; and lithium (Li)-based ferrites.

The second metallic magnetic particle P2 may include the same material as the first metallic magnetic particle P1. However, the second metallic magnetic particle P2 is not limited thereto, and may include a material different from the first metallic magnetic particle P1.

An average particle size of the first metallic magnetic particle P1 may be larger than an average particle size of the second metallic magnetic particle P2. In the specification, the term “particle size” may refer to a particle size distribution expressed as D90 or D50. In an example, the second metallic magnetic particle P2 may use a fine or ultrafine metal powder. However, the second metallic magnetic particle P2 is not limited thereto, and the average particle size of the second metallic magnetic particle P2 may be larger than the average particle size of the first metallic magnetic particle P1.

Meanwhile, an average of particle sizes may indicate an average value of the particle sizes calculated by capturing ten points at equal intervals in the third direction or the second direction of the coil component with respect to a third-direction–first-direction cross-section or a second-direction–first-direction cross-section using a scanning electron microscope (SEM) and then using an image analysis program (e.g., LAS X Grain Expert by Leica Microsystem GmbH).

The second metallic magnetic particle P2 may have an average diameter of 80 μm or less. When the average diameter of the second metallic magnetic particle P2 exceeds 80 μm, it may become difficult to adjust a thickness of the shielding layer 700.

Referring to FIG. 7, the second metallic magnetic particle P2 may include an insulating film F2. The insulating film F2 may be formed on a surface of the second metallic magnetic particle P2. The insulating film F2 may include, for example, epoxy, polyimide, or a liquid crystal polymer alone or in combination, or may include silica (SiO₂) or alumina (Al2O₃), or may be an oxide film including a metal included in the second metallic magnetic particle P2. The insulating film F2 may have an average thickness ranging from 20 nm to 1 μm.

The insulating film F2 disposed on the surface of the second metallic magnetic particle P2 may have an average thickness greater than an average thickness of the insulating film F1 disposed on the surface of the first metallic magnetic particle P1. The shielding layer 700 may be in contact with the external electrode 500, and during plating of the external electrode 500, a plating spread phenomenon may occur due to the metallic magnetic particle P2 included in the shielding layer, which may degrade reliability of the coil component 1000. Therefore, the plating spread phenomenon may be controlled by reinforcing of the second metallic magnetic particle P2 by the insulating film F2. Accordingly, as illustrated in FIG. 6, the external electrode 500 may not extend onto the outer surface in the second direction (i.e. the Y-direction) of the shielding layer 700.

Meanwhile, the average thickness of the insulating films F1 and F2 disposed on the metallic magnetic particle P1 and P2 may be measured as an average value of thicknesses of the insulating films on the third-direction–first-direction cross-section or second-direction–first-direction cross-section of the coil component that is formed by polishing the coil component in the second direction or the third direction. For example, the third-direction–first-direction cross-section may be applied to analyses using at least one of Transmission Electron Microscopy (TEM), Atomic Force Microscope (AFM), Scanning Electron Microscope (SEM), an optical microscope, and a surface profiler, and dimensions may be measured by visual confirmation of images obtained based on the analyses or by image processing (e.g., identifying pixels based on colors or brightness of pixels, filtering pixel values for pixel-identification efficiency, or integrating distances between identified pixels).

The shielding layer 700 may include two or more types of the second metallic magnetic particle P2 dispersed in a resin. Here, the second metallic magnetic particle of different types indicates that the second metallic magnetic particles are distinguished from each other based on any one of an average diameter, a composition, a crystallinity, and a shape.

The resin may include epoxy, polyimide, or a liquid crystal polymer alone or in combination. However, the resin is not limited thereto.

The coil insulating film IF may be disposed between the coil 300 and the body 100 and between the support member 200 and the body 100. The coil insulating film IF may be formed along surfaces of the lead-out portions 331 and 332, the coil patterns 311 and 312, the support member 200, and the auxiliary lead-out portions 341 and 342. However, the coil insulating film IF is not limited thereto. The coil insulating film IF is provided for insulating the coil 300 and the body 100, may include a known insulating material such as parylene, and is not limited thereto. In another example, the coil insulating film IF may include an insulating material such as an epoxy resin rather than parylene. The coil insulating film IF may be formed by a vapor deposition method, and is not limited thereto. In another example, the coil insulating film IF may be formed by stacking and curing an insulating film for forming the coil insulating film IF on both surfaces of the support member 200 on which the coil 300 is formed, or may be formed by applying and curing an insulating paste for forming the coil insulating film IF on both surfaces of the support member 200 on which the coil 300 is formed. Meanwhile, for the reasons described above, the coil insulating film IF is a configuration that may be omitted in this exemplary embodiment. That is, if the body 100 has sufficient insulation resistance at designed operation current and voltage, the coil insulating film IF may be omitted in this exemplary embodiment.

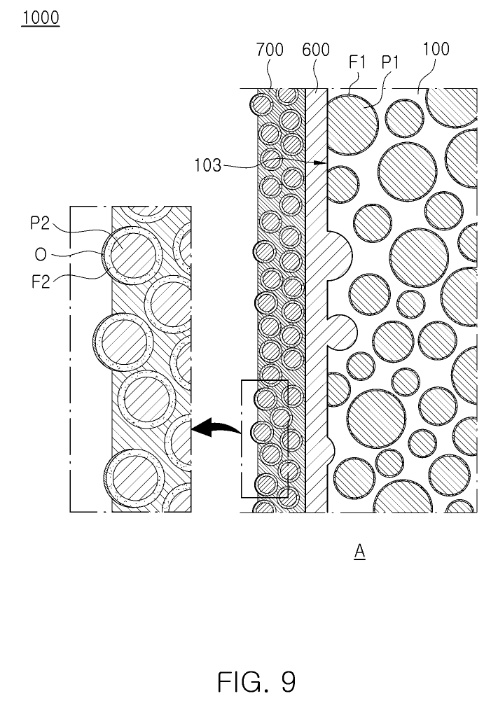

FIG. 9 is a view illustrating a modified example of FIG. 7.

Referring to FIG. 9, at least a portion of the second metallic magnetic particle P2 may be exposed to the outer surface of the shielding layer 700, and an additional insulating film O may be disposed on the surface of the second metallic magnetic particle P2 exposed to the outer surface of the shielding layer 700. Therefore, the insulating film F2 of the second metallic magnetic particle P2 extending to the outer surface of the shielding layer may have an average thickness greater than an average thickness of the insulating film F2 of the second metallic magnetic particle P2 disposed inside the shielding layer.

The plating spread phenomenon during the formation of the external electrode (e.g., external electrode 150) may be controlled by forming the additional insulating film O on the second metallic magnetic particle P2 extending to the outer surface of the shielding layer.

The additional insulating film O may be formed by performing an acid treatment on the metallic magnetic particle P2 exposed to the outer surface of the shielding layer 700. In this case, an acid treatment solution may selectively react with the exposed metallic magnetic particle P2 to form the additional insulating film O, and the additional insulating film O may thus include a metal component of the exposed metallic magnetic particle P2. However, the additional insulating film O is not limited thereto, and may also be formed by performing a phosphate treatment on the metallic magnetic particle P2 exposed to the outer surface of the shielding layer 700.

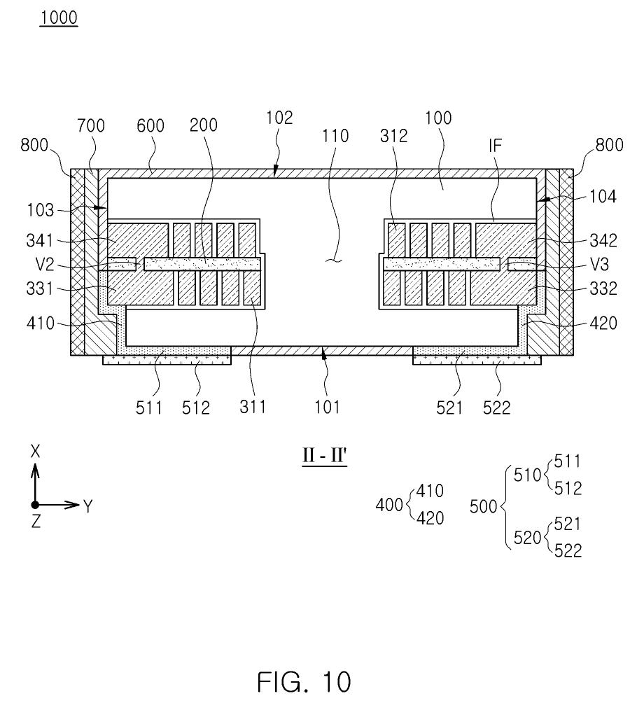

FIG. 10 is a view illustrating a modified example of FIG. 6.

Referring to FIG. 10, a second insulating layer 800 may be disposed on the outer surface of the shielding layer 700. The plating spread phenomenon may be controlled by disposing the second insulating layer 800 on the outer surface of the shielding layer 700 instead of reinforcing the metallic magnetic particle P2 of the shielding layer 700 by the insulating film F2.

The second insulating layer 800 may include a thermoplastic resin such as a polystyrene-based resin, a vinyl acetate-based resin, a polyester-based resin, a polyethylene-based resin, a polypropylene-based resin, a polyamide-based resin, a rubber-based resin, or an acrylic-based resin, a thermosetting resin such as a phenol-based resin, an epoxy-based resin, a urethane-based resin, a melamine-based resin, or an alkyd-based resin, a photosensitive resin, parylene, silicon oxide (SiOₓ), or silicon nitride (SiNₓ). The second insulating layer 800 may further include an insulating filler such as an inorganic filler and is not limited thereto.

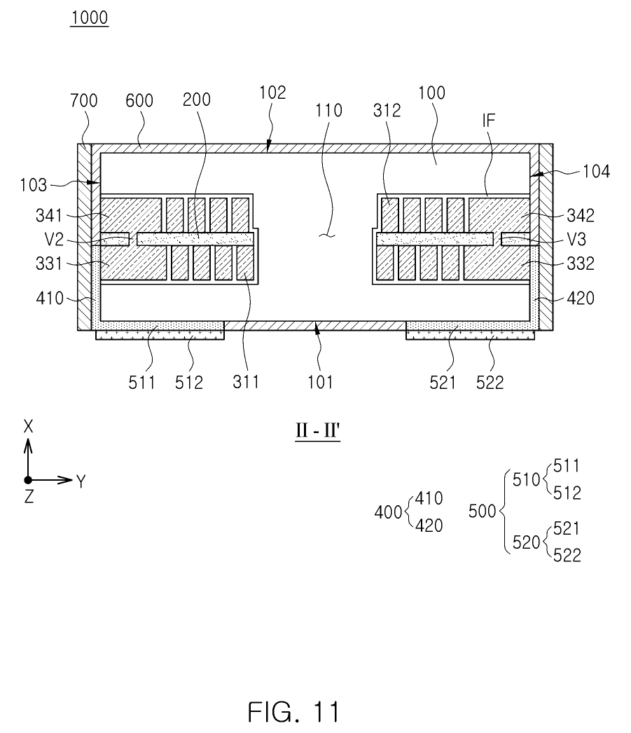

FIG. 11 is a view illustrating another modified example of FIG. 6.

Referring to FIG. 11, the groove G may not be formed on the third and fourth surfaces 103 and 104 of the body 100 according to another modified example.

The first lead-out portion 331 may extend to the third surface 103, and the first connection portion 410 may be connected to the first lead-out portion 331 exposed to the third surface 103. The shielding layer 700 may be disposed on the first connection portion 410 and may not fill the groove G.

Similarly, the second lead-out portion 332 may extend to the fourth surface 104, and the second connection portion 420 may be connected to the second lead-out portion 332 exposed to the fourth surface 104. The shielding layer 700 may be disposed on the second connection portion 420 and may not fill the groove G.

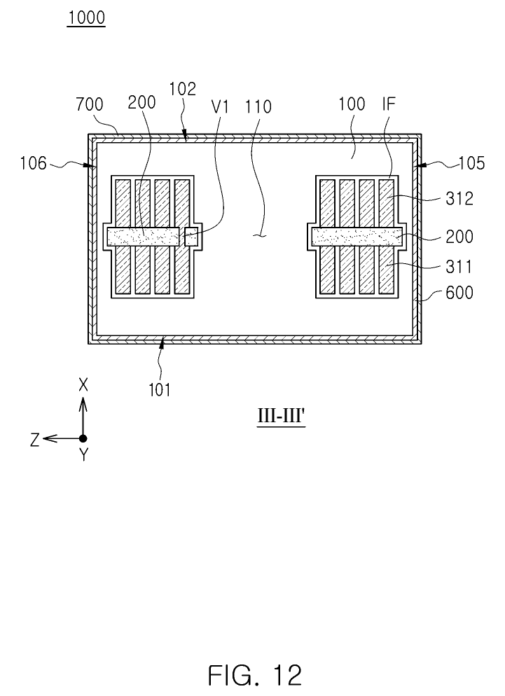

FIG. 12 is a view illustrating a modified example of FIG. 8.

Referring to FIG. 12, the shielding layer 700 may be disposed on the first surface 101, second surface 102, fifth surface 105, and sixth surface 106 of the body 100 according to the modified example. That is, the electrical side effect such as the EMI radiation may be further reduced by forming the shielding layer on the six surfaces of the body 100.

### Second exemplary embodiment

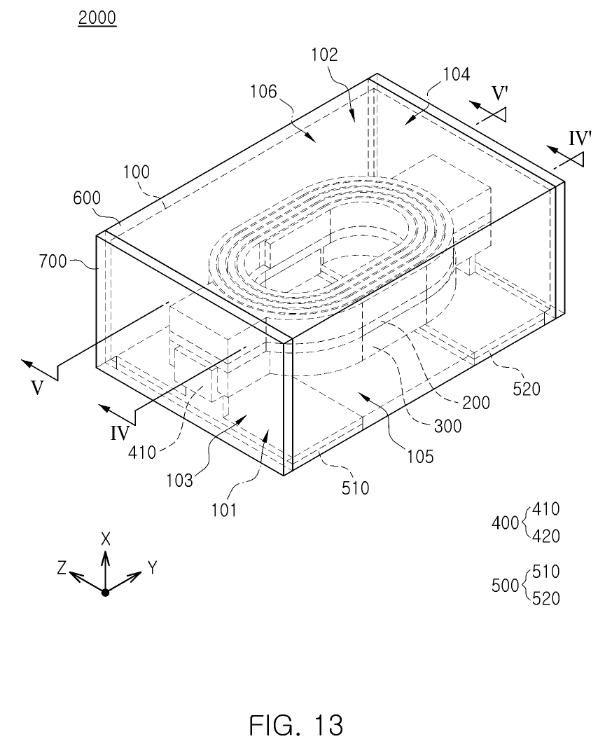

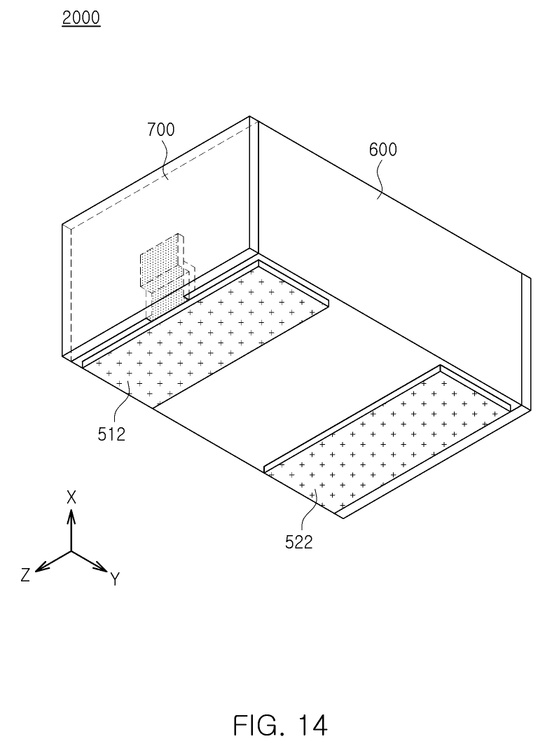

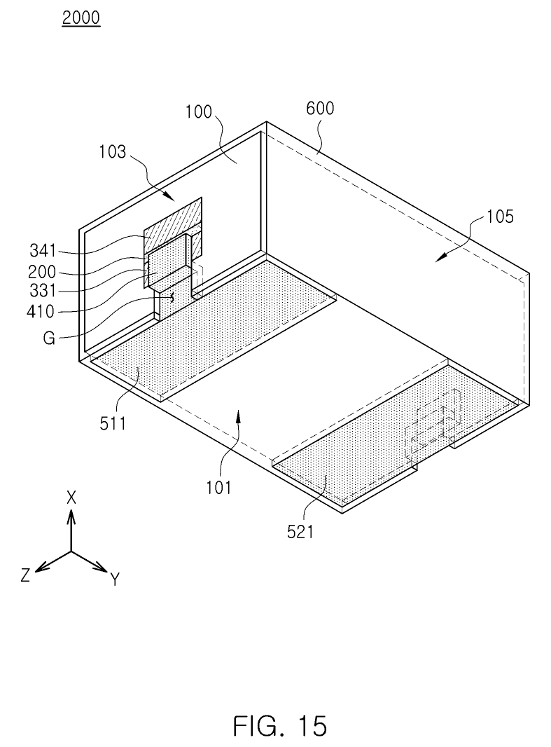

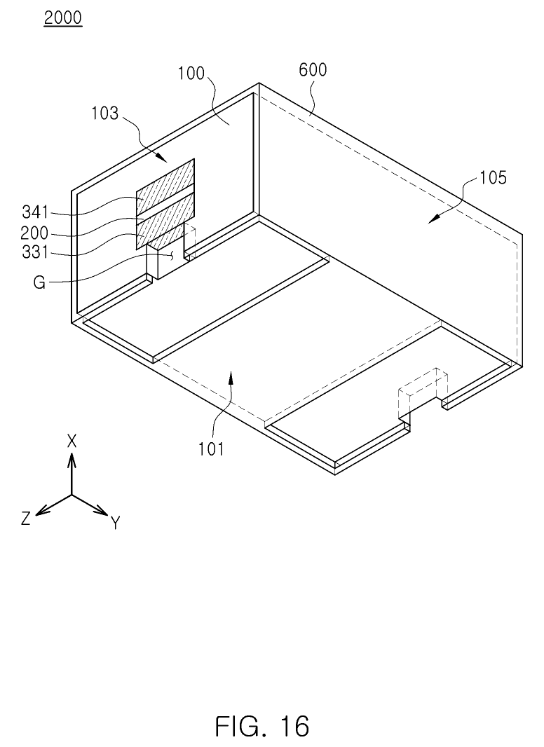

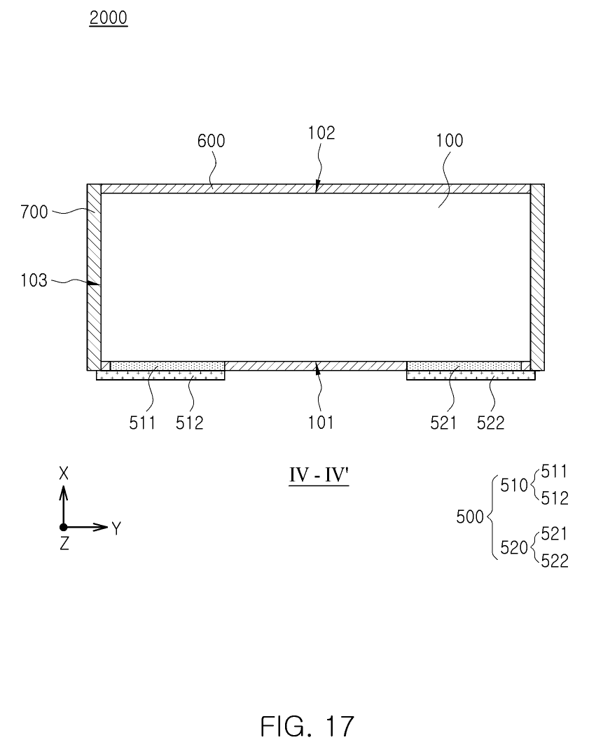

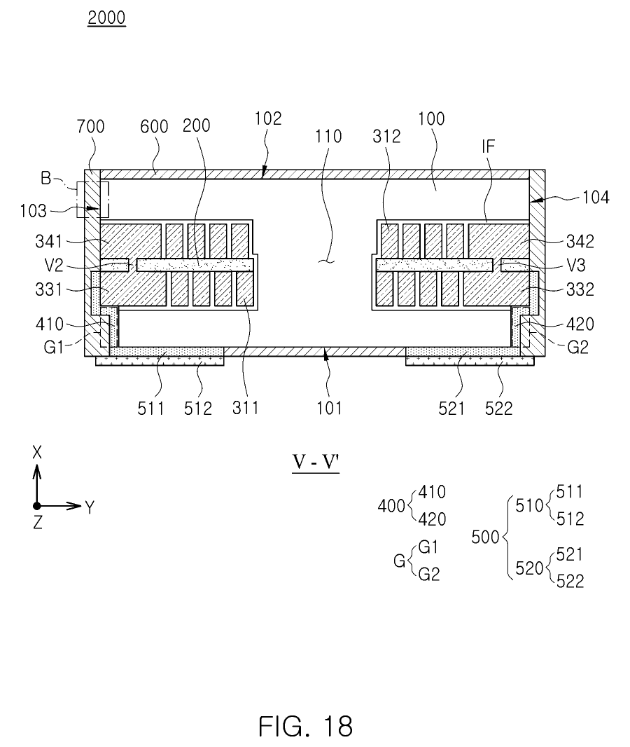

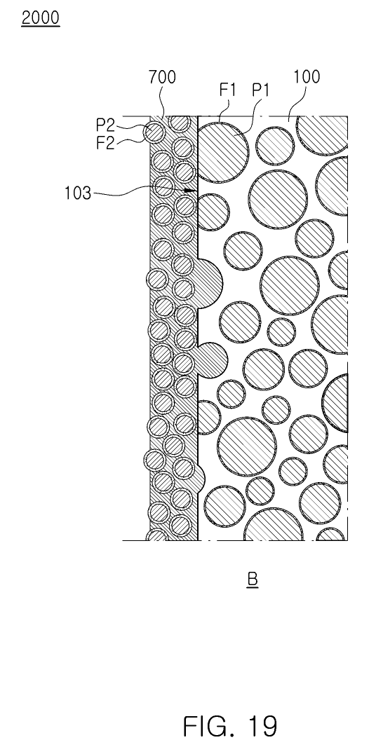

FIG. 13 is a perspective sectional view schematically illustrating a coil component according to a second exemplary embodiment of the present disclosure. FIG. 14 is a view illustrating the coil component according to a second exemplary embodiment of the present disclosure as viewed from the bottom. FIG. 15 is a view illustrating a state where a shielding layer is omitted from FIG. 14. FIG. 16 is a view illustrating a state where an external electrode is omitted from FIG. 15. FIG. 17 is a cross-sectional view taken along line IV-IV' in FIG. 13. FIG. 18 is a cross-sectional view taken along line V-V' in FIG. 13. FIG. 19 is an enlarged view of portion B in FIG. 18.

Hereinafter, with reference to FIGS. 13 to 19, a coil component 2000 according to a second exemplary embodiment of the present disclosure will be described, focusing on parts different from the coil component 1000 according to the first exemplary embodiment. The remaining configurations may be applied as described in the first exemplary embodiment.

In the coil component 2000 according to a second exemplary embodiment, the first insulating layer 600 may not be disposed on the third surface 103 or the fourth surface 104 of the body 100. After forming the connection portion 400 and the external electrode 500 by using the first insulating layer 600 as a plating resist, the first insulating layer 600 disposed on the third surface 103 and the fourth surface 104 of the body 100 may be removed by laser peeling. In this case, the shielding layer 700 may be in direct contact with the surface of the body 100, thereby improving adhesion between the shielding layer 700 and the body 100.

The first insulating layer 600 may be disposed on the first, second, fifth, and sixth surfaces 101, 102, 105, and 106 of the body 100 excluding the third surface 103 and the fourth surface 104 in the same manner as described in a first exemplary embodiment.

Referring to FIGS. 18 and 19, the shielding layer 700 may be directly disposed on the third surface 103 and the fourth surface 104 of the body 100. The shielding layer 700 may be in contact with the cut surface of the first metallic magnetic particle P1 extending to the third surface 103 of the body 100.

In addition, the shielding layer 700 may be in contact with the lead-out portions 331 and 332 and the auxiliary lead-out portions 341 and 342 extending to the third surface 103 and the fourth surface 104.

Referring to FIG. 19, the shielding layer 700 may be in contact with the cut surface of the first metallic magnetic particle P1 and may fill a portion where the first metallic magnetic particle P1 is fallen off. In addition, the third surface 103 of the body and the shielding layer 700 may form a discontinuous interface. Specifically, due to differences such as microstructural differences between magnetic sheets and thermal stresses during heat treatment in a curing process, the discontinuous interface may be formed between the body 100 and the shielding layer 700. However, discontinuity is not limited thereto and may occur at the interface for reasons such as minute pores in the magnetic sheet not being filled.

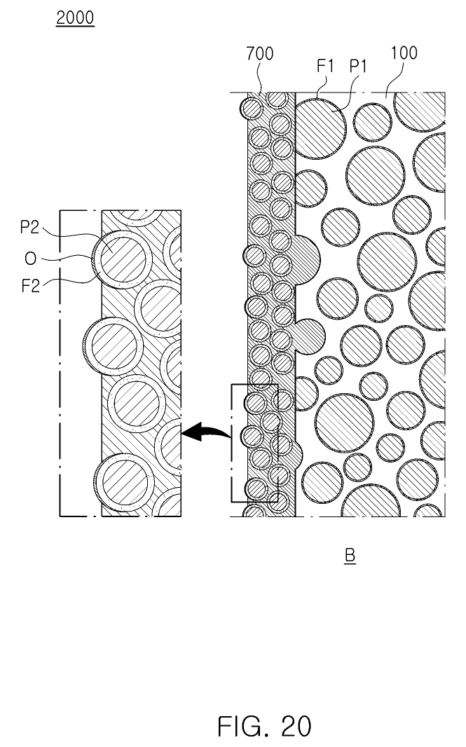

FIG. 20 is a view illustrating a modified example of FIG. 19.

Referring to FIG. 20, at least a portion of the second metallic magnetic particle P2 may be exposed to the outer surface of the shielding layer 700, and the additional insulating film O may be disposed on the surface of the second metallic magnetic particle P2 exposed to the outer surface of the shielding layer 700. Therefore, the insulating film F2 of the second metallic magnetic particle P2 extending to the outer surface of the shielding layer may have an average thickness greater than an average thickness of the insulating film F2 of the second metallic magnetic particle P2 disposed inside the shielding layer.

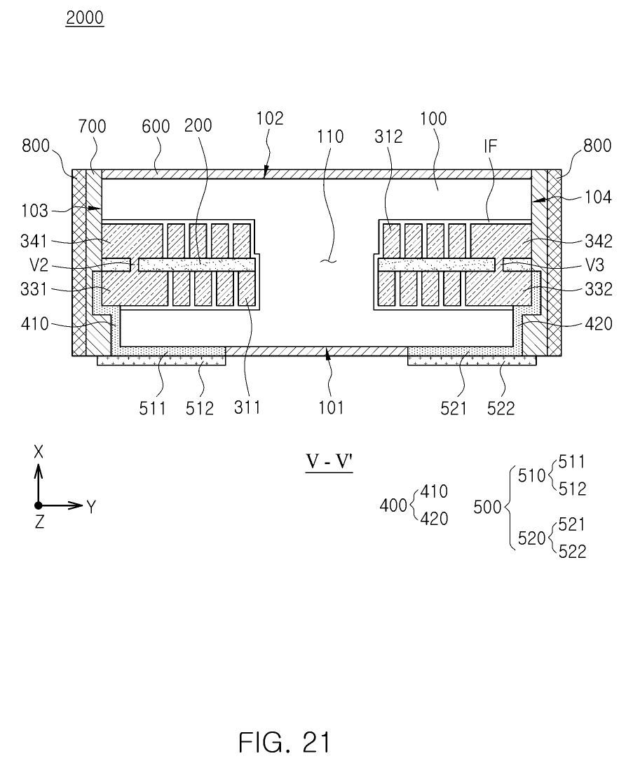

FIG. 21 is a view illustrating a modified example of FIG. 18.

Referring to FIG. 21, the second insulating layer 800 may be disposed on the outer surface of the shielding layer 700. The plating spread phenomenon may be controlled by disposing the second insulating layer 800 on the outer surface of the shielding layer 700 instead of reinforcing the metallic magnetic particle P2 of the shielding layer 700 by the insulating film F2.

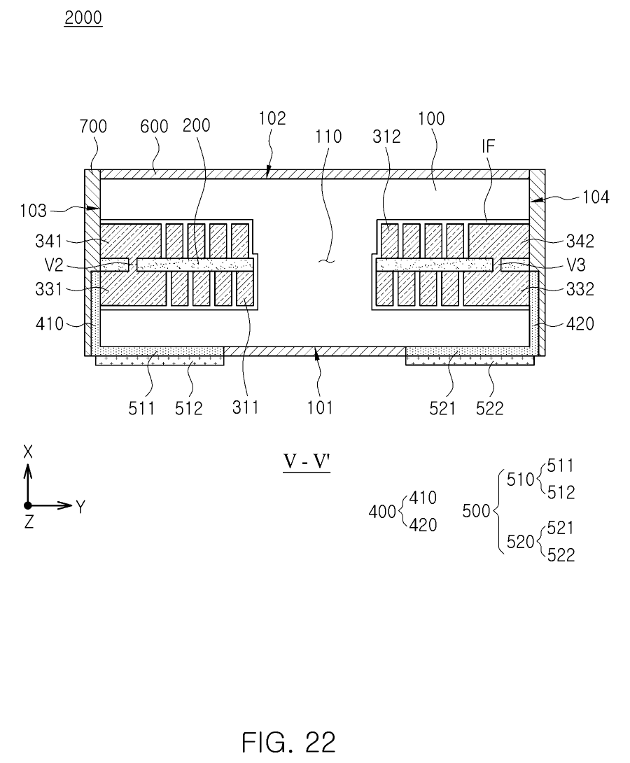

FIG. 22 is a view illustrating another modified example of FIG. 18.

Referring to FIG. 22, the groove G may not be formed on the third surface 103 of the body 100 according to another modified example.

The first lead-out portion 331 may extend to the third surface 103, and the first connection portion 410 may be connected to the first lead-out portion 331 exposed to the third surface 103. The shielding layer 700 may be disposed on the first connection portion 410 and may not fill the groove G.

Similarly, the second lead-out portion 332 may extend to the fourth surface 104, and the second connection portion 420 may be connected to the second lead-out portion 332 exposed to the fourth surface 104. The shielding layer 700 may be disposed on the second connection portion 420 and may not fill the groove G.

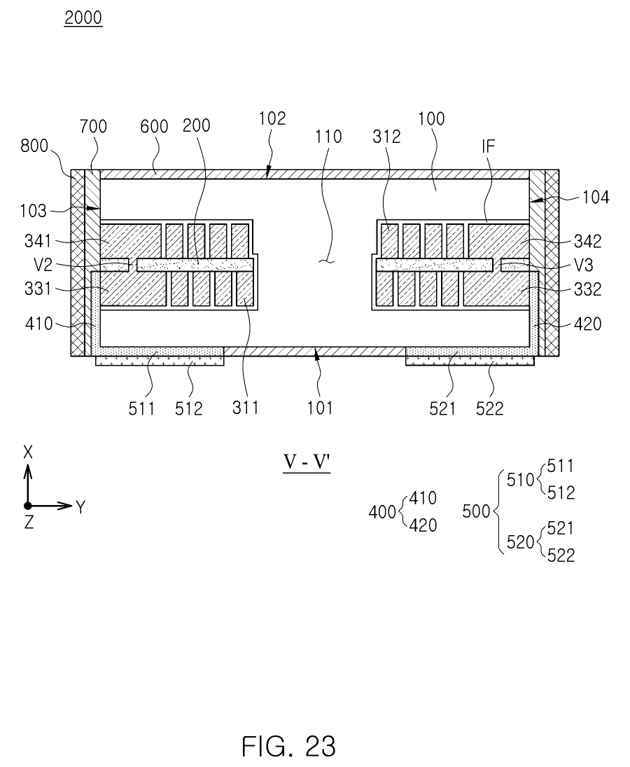

FIG. 23 is a view illustrating another modified example of FIG. 18.

Referring to FIG. 23, the groove G may not be formed on the third surface 103 of the coil component according to another modified example. Furthermore, the second insulating layer 800 may be disposed on the outer surface of the shielding layer 700. The plating spread phenomenon during the formation of the external electrode may be controlled by disposing the second insulating layer 800 on the outer surface of the shielding layer 700.

### Third exemplary embodiment

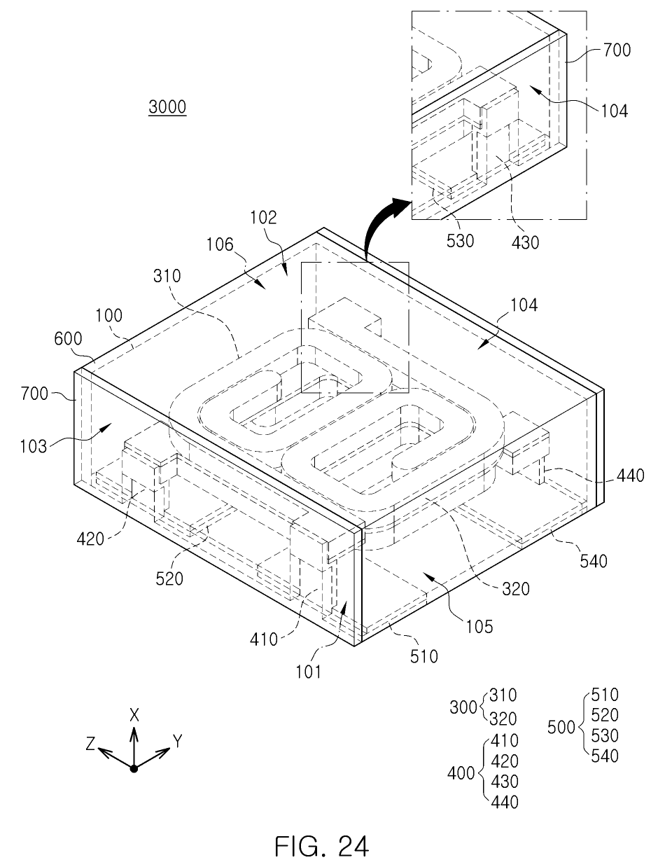

FIG. 24 is a perspective view illustrating a coil component according to a third exemplary embodiment. Referring to FIG. 24, a coil component 3000 according to a third exemplary embodiment may include a plurality of coils, that is, a first coil 310 and a second coil 320. That is, the coil component 3000 according to a third exemplary embodiment may have an array form and, specifically, may be a coupled inductor. However, the coil component 3000 is not limited thereto.

The coil component 3000 according to a third exemplary embodiment may include the first coil 310 and the second coil 320. The first coil 310 and the second coil 320 may be disposed on the support member 200 to be spaced apart from each other.

The coil component 3000 according to a third exemplary embodiment may include first to fourth external electrodes 510, 520, 530, and 540, and the external electrodes may be disposed on the first surface 101 to be spaced apart from each other. One end of the first coil 310 may be connected to the first external electrode 510 through the first connection portion 410, and the other end of the first coil 310 may be connected to the second external electrode 520 through the second connection portion 420. One end of the second coil 320 may be connected to the third external electrode 530 through the third connection portion 430, and the other end of the second coil 320 may be connected to the fourth external electrode 540 through the fourth connection portion 440.

The remaining configurations may be applied as described in a first exemplary embodiment as it is.

### Fourth exemplary embodiment

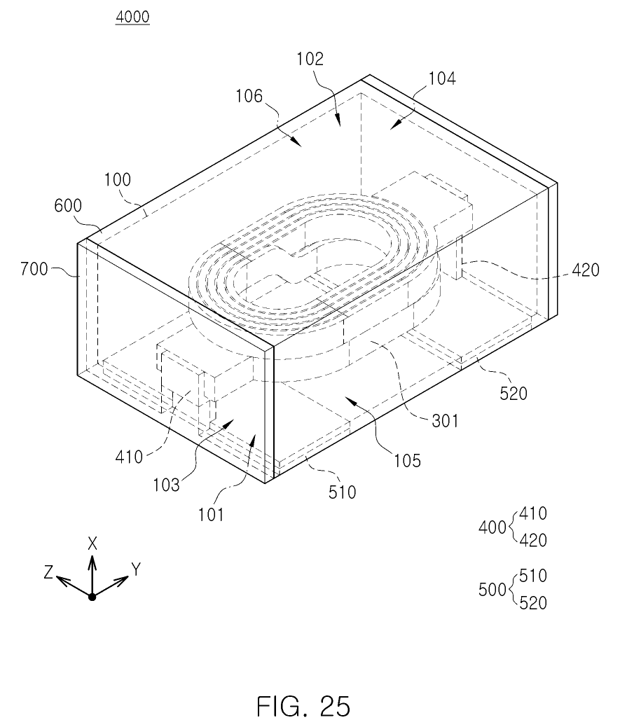

FIG. 25 is a perspective sectional view schematically illustrating a coil component according to a fourth exemplary embodiment of the present disclosure. Referring to FIG. 25, a coil component 4000 according to a fourth exemplary embodiment may be a wound-type coil component. Hereinafter, descriptions will focus on parts different between the coil component 4000 according to a fourth exemplary embodiment and the coil component 1000 according to a first exemplary embodiment. The remaining configurations may be applied as described in a first exemplary embodiment as it is.

A wound coil 301 of the coil component 4000 according to a fourth exemplary embodiment may be similar to the coil 300 of the coil components 1000, 2000, 3000, except that the wound coil 301 is a wound-type coil. The coil component 4000 according to a fourth exemplary embodiment may not include the support member 200 as a configuration.

The wound coil 300 may be wound around a core. The wound coil 300 may be formed by winding a metal wire such as a copper wire whose surface is covered with an insulating film (e.g. coil insulating film IF) in a spiral shape. As a result, each turn of the wound coil 300 may have a form covered with the insulating film.

### Fifth exemplary embodiment

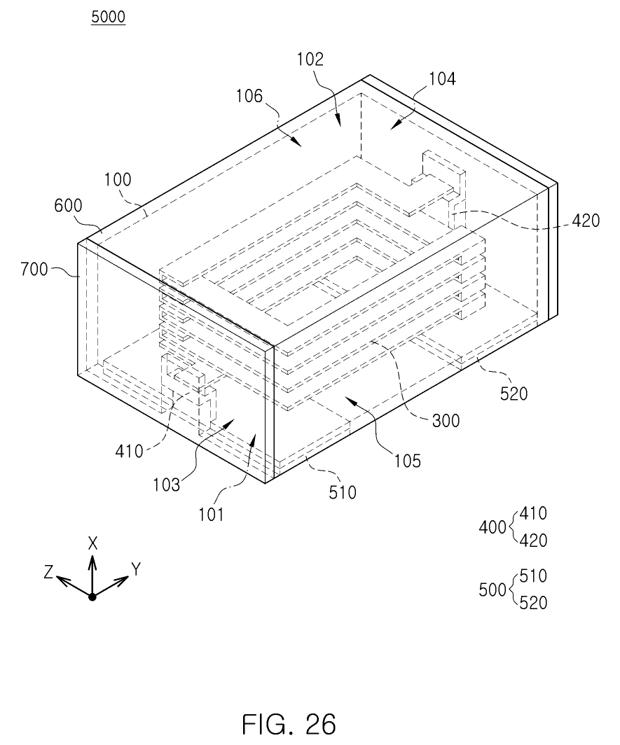

FIG. 26 is a perspective sectional view schematically illustrating a coil component according to a fifth exemplary embodiment of the present disclosure. Referring to FIG. 26, the coil component 5000 according to a fifth exemplary embodiment may be a stacked-type coil component. Hereinafter, descriptions will focus on parts different between the coil component 5000 according to a fifth exemplary embodiment and the coil component 1000 according to a first exemplary embodiment. The remaining configurations may be applied as described in a first exemplary embodiment as it is.

A body 100 of the coil component 5000 according to a fifth exemplary embodiment may have a plurality of stacked magnetic sheets. That is, the body 100 of the coil component 5000 according to a fifth exemplary embodiment may be obtained by stacking the plurality of magnetic sheets including a magnetic material in the first direction (i.e., the X-direction) and then sintering the same. On the plurality of magnetic sheets, a conductor pattern may be formed on one surface of each sheet, and the conductor patterns may be electrically connected to each other through conductive vias formed in adjacent magnetic sheets to form the coil 300.

The conductor pattern may be formed on a green sheet for forming the magnetic sheet by performing thick-film printing, application, deposition, sputtering, and the like on a conductive paste for forming the conductor pattern. However, the conductor pattern is not limited thereto.

The conductive vias may be formed by forming through-holes in each sheet in the thickness direction and then filling the through-holes with the conductive paste. However, the conductive vias are not limited thereto.

As set forth above, according to the exemplary embodiments of the present disclosure, the electrical side effect that may occur due to the connection electrode of the coil component may be improved.

According to the exemplary embodiments of the present disclosure, the plating spread phenomenon may be controlled during the external electrode plating of the coil component.

While the exemplary embodiments have been shown and described above, it will be apparent to those skilled in the art that modifications and variations could be made without departing from the scope of the present disclosure as defined by the appended claims.

What is claimed is:

1. A coil component comprising:
a body having a first surface, a second surface opposing the first surface in a first direction, and a third surface connecting the first surface to the second surface, and including a first metallic magnetic particle;
a coil disposed in the body and having one end extending to the third surface of the body;
a connection portion connected to the one end of the coil and extending to the first surface of the body; and
a shielding layer disposed on the third surface of the body and on the connection portion, and including a second metallic magnetic particle,
wherein at least a portion of the first metallic magnetic particle extends to the third surface of the body, and
at least a portion of the first metallic magnetic particle extending to the third surface of the body includes a cut surface.

2. The coil component of claim 1, wherein the cut surface is in contact with the shielding layer.

3. The coil component of claim 1, wherein a thickness of the shielding layer satisfies a range of 5 μm to 100 μm.

4. The coil component of claim 1, wherein the second metallic magnetic particle includes an insulating film, and
the insulating film of the second metallic magnetic particle extends to a surface of the shielding layer and has an average thickness greater than an average thickness of another insulating film of another second metallic magnetic particle disposed inside the shielding layer.

5. The coil component of claim 1, further comprising an additional insulating film disposed on the second metallic magnetic particle, wherein the second metallic magnetic particle extends to a surface of the shielding layer.

6. The coil component of claim 1, wherein each of the first and second metallic magnetic particles includes a respective insulating film, and
the insulating film of the second metallic magnetic particle has an average thickness greater than an average thickness of the insulating film of the first metallic magnetic particle.

7. The coil component of claim 1, further comprising an external electrode disposed on the first surface of the body and connected to the connection portion.

8. The coil component of claim 7, wherein the shielding layer includes an inner surface in contact with the connection portion and an outer surface opposing the inner surface, and
the external electrode does not extend onto the outer surface of the shielding layer.

9. The coil component of claim 1, wherein the body further includes a fourth surface opposing the third surface in a second direction, and a fifth surface and a sixth surface connecting the third surface and the fourth surface to each other and opposing each other in a third direction.

10. The coil component of claim 9, wherein a length of the connection portion in the third direction is referred to as a, a length of the body in the third direction is referred to as b, and a/b satisfies a range of 0.05 to 0.7.

11. The coil component of claim 1, further comprising a support member disposed in the body,
wherein the coil is disposed on one surface of the support member.

12. The coil component of claim 11, wherein the coil includes a first coil pattern, a first lead-out portion, and a second lead-out portion disposed on one surface of the support member, and a second coil pattern and an auxiliary lead-out portion disposed on another surface of the support member.

13. The coil component of claim 1, further comprising a first insulating layer disposed on the second surface of the body.

14. The coil component of claim 1, further comprising a first insulating layer disposed between the shielding layer and the third surface of the body.

15. The coil component of claim 14, wherein the first insulating layer is in contact with the cut surface.

16. The coil component of claim 1, further comprising a second insulating layer disposed on the shielding layer.

17. The coil component of claim 1, wherein the coil includes first and second coils spaced apart from each other.

18. The coil component of claim 1, wherein the coil is a wound-type coil.

19. The coil component of claim 1, wherein the body is a stack in which a plurality of sheets are stacked, and
the coil is formed on each of the plurality of sheets.

20. The coil component of claim 9, wherein the shielding layer is also disposed on the fifth and sixth surfaces of the body.

21. A coil component comprising:
a body having a first surface, a second surface opposing the first surface in a first direction, and a third surface connecting the first surface to the second surface, and including a first metallic magnetic particle;
a groove formed in the third surface of the body and including an inner surface positioned inside the body relative to the third surface;
a coil disposed in the body and having one end extending to the third surface of the body;
a connection portion connected to the one end of the coil and extending to the first surface of the body; and
a shielding layer disposed on the third surface of the body and on the connection portion, and including a second metallic magnetic particle,
wherein the shielding layer fills at least a portion of the groove.

22. A coil component comprising:
a body having a first surface, a second surface opposing the first surface in a first direction, and a third surface connecting the first surface to the second surface, and including a first metallic magnetic particle;
a coil disposed in the body and having one end extending to the third surface of the body;
a connection portion connected to the one end of the coil and extending to the first surface of the body; and
a shielding layer disposed on the third surface of the body and on the connection portion, and including a second metallic magnetic particle,
wherein the third surface of the body and the shielding layer form a discontinuous interface.

23. A coil component comprising:
a body having a first surface, a second surface opposing the first surface in a first direction, and a third surface connecting the first surface to the second surface, and including a first metallic magnetic particle;
a coil disposed in the body and having one end extending to the third surface of the body;
a connection portion connected to the one end of the coil and extending to the first surface of the body; and
a shielding layer disposed on the third surface of the body and on the connection portion, and including a second metallic magnetic particle,
wherein an average particle size of the first metallic magnetic particle is larger than an average particle size of the second metallic magnetic particle.
